(19) United States
(12) Patent Application Publication
(10) Pub. No.: US 2022/0206863 A1
(43) Pub. Date: Jun. 30, 2022

(54) APPARATUS AND METHOD TO DYNAMICALLY OPTIMIZE PARALLEL COMPUTATIONS

(71) Applicant: Bernhard Frohwitter, Munchen (DE)

(72) Inventors: Bernhard Frohwitter, Munchen (DE); Thomas Lippert, Aschaffenburg (DE)

(21) Appl. No.: 17/605,530

(22) PCT Filed: Apr. 29, 2020
(86) PCT No.: PCT/EP2020/061887

§ 371 Date: Oct. 21, 2021

(30) Foreign Application Priority Data
Apr. 30, 2019 (EP) 19171779.2

(51) Int. Cl. G06F 9/50; G06F 9/38

(52) U.S. Cl. CPC G06F 9/5044; G06F 9/3877; G06F 9/5072; G06F 9/505

(57) ABSTRACT

The invention provides a method of optimizing a parallel computing system including a plurality of processing element types by applying a generalized Amdahl law relating a speed-up of the system, numbers of the processing elements of each type and a fraction of a code portion of each concurrency which is parallelizable. The invention can be used to determine a change in accelerator processing elements required to obtain a desired speed-up

The present invention relates to optimizing the processing capability of a parallel computing system.

An exponential increase in computing power that is available in supercomputer and data centres which has been observed over the last three decades is largely a result of increased parallelism, which allows for increased concurrency of computations on the chip (multiple cores), on the node (multiple CPUs) and at a system level (increasing number of nodes in a system). While on-chip parallelism has partially kept energy consumption per chip to remain constant as the number of cores increases, the number of CPUs per node and the number of nodes in a system proportionally increase the power requirements and the required investments.

At the same time, it becomes evident that the various and different computational tasks might be most effectively carried out on different types of hardware. Examples of such compute elements are multi-threaded multi-core CPUs, many core CPUs, GPUs, TPUs, or FPGAs. Also processors equipped with different types of cores are on the horizon, as for instance CPUs with added data flow co-processors like Intel's configurable spatial accelerator (CSA). Examples of different categories of computational tasks on the side of science are, among many many others, matrix multiplications, sparse matrix multiplications, stencil based simulations, event-based simulations, deep learning problems etc, in industry one specifically finds workflows in operation research, computational fluid dynamics (CFD), drug design etc. Data intensive computations have become to dominate highly parallel computing (HPC) and are becoming ever more important in data centres. It is obvious that one needs to utilize the most power efficient compute elements for a given task.

What is more, with the increasing complexity of the calculations, the combination of methodological aspects and categories of calculation tasks becomes more and more important. Workflows are going to dominate the work in supercomputing centres, the scalability of individual programs on different levels of parallelism poses increasing problems, and the heterogeneity of tasks performed in data centres is expected to dominate operations. A typical example is the dynamical assignment of (high throughput) deep learning tasks invoked from a web based query, often involving the extensive use of data bases, as encountered in data centres.

It is clear that the combination and interaction of different hardware resources in the sense of a modular supercomputing system, such as that described in WO 2012/049247, or different modules in a data centre adapted to the different tasks to be performed has become a giant technological challenge if one has to meet the requirements of today's und future complex computing problems.

Considerations for the design of an accelerated cluster architecture for Exascale computing are set out in the paper “An accelerated Cluster-Architecture for the Exascale” by N. Eicker and Th. Lippert, in PARS ‘11, PARS-Mitteilungen, Mitteilungen—Gesellschaft für Informatik e.V., Parallel-Algorithmen und Rechnerstrukturen, pp 110-119, in which the relevancy of Amdahl's law is discussed.

The original version of Amdahl's law (AL), as discussed in “Validity of the Single Processor Approach to Achieving Large-Scale Computing Capabilities” by Gene Amdahl in AFIPS Conference Proceedings. Band 30, 1967, S. 483-485, defines an upper limit of the speed-up S for computing a problem by means of parallel computing in a highly idealized setting. AL may be expressed in words as “in parallelization, if p is the proportion of a system or program that can be made parallel, and 1-p is the proportion that remains serial, then the maximum speedup that can be achieved using k number of processors is

$$1 \text{/} {( 1 - p + \frac{p}{k} )}^{″}$$

(see https://www.techopedia.com/definition/17035/amdahls-law).

Amdahl's original example is concerning scalar and parallel code portions of a calculation problem, which are both executed on compute elements of the same technical type. For applications dominated by numerical operations, such code portions can be reasonably specified as the ratios of numbers of floating point operations (flop), for other type of operations like integer computations, equivalent definitions can be given. Let the scalar code portion, s, that cannot be parallelized, be characterized by the number of scalar flop divided by the total number of flop occurring during the execution of the code,

$$s = \frac{number of scalar flop}{total number of flop} ,$$

and similarly, the parallel code portion, p, that can be distributed to k compute elements for parallel execution, be characterized by the number of parallelizable flop divided by the total number of flop occurring during the execution of the code,

$$p = \frac{number of parallelizable flop}{total number of flop} .$$

Thus, s=1−p, as introduced above. The execution time of the scalar portion obviously is proportional to s, as it can be computed on one compute element only, while the

execution time of the portion p can be computed in a time proportional to

$$\frac{1}{k}$$

of p, as the load can be distributed over k compute elements. Therefore, the speed-up S is given by

$$S = \frac{1}{s + \frac{p}{k}}$$

This formula is called AL. Fork approaching infinity, i.e., if the parallel code portion is assumed to be infinitely scalable, an asymptotic speed-up Sₐ can be derived,

$${S}_{a} = {lim}_{k \to ∞} \frac{1}{s + \frac{p}{k}} = \frac{1}{s} ,$$

which simply is the inverse of the scalar code portion, s. It is important to note that Amdahl's Law in this form does not take into account other limiting factors as latency and communication performance. They will further decrease Sₐ. On the other hand, cache technologies can improve the situation. However, the basic limitations through the AL will hold under the given assumptions.

From AL it becomes obvious that one needs to reduce the percentage of s in order to achieve a reasonable speed-up.

The present invention provides a method of assigning resources of a parallel computing system for processing one or more computing applications, the parallel computing system including a predetermined number of processing elements of different types, at least a predetermined number of a first type and at least a predetermined number of processing elements of a second type, the method comprising for each computing application for each type of processing element, determining a parameter for the application indicative of a portion of application code which can be processed in parallel by the processing elements of that type; determining, using the parameters obtained for the processing of the application by the processing elements of the at least first and at least second type, a degree by which an expected processing time of the application would be changed by varying a number of processing elements of one or more of the types; and assigning processing elements of the at least first and at least second type to the one or more computing applications so as to optimize a utilization of the processing elements of the parallel computing system.

In a further aspect, the invention provides a method of designing a parallel computing system having a plurality of processing elements of different types, including at least a plurality of processing elements of a first type and at least a plurality of processing elements of a second type, the method comprising for each type of processing element, determining a parameter indicative of a proportion of a respective processing task which can be processed in parallel by the processing elements of that type; determining an optimal number of processing elements of at least one of the first and second types by one of: (i) determining a point at which a processing speed of the system for the application does not change with number of processing elements of that type in an equation relating the processing speed, the parameters for the processing elements of the first and second type, a number of processing elements of the first type, a number of processing elements of that type and costs of the processing elements of the first and second type; and (ii) for a desired change in processing time in a parallel computing system, using the parameters determined for each type of processing element to determine a sufficient change in a number of processing elements required to obtain the desired change in processing time, and using the determined optimal number to construct the parallel computing system.

In a still further aspect, the invention provides a method of assigning resources of a parallel computing system for processing one or more computing applications, the parallel computing system including a plurality of processing elements of different types, including at least a plurality of processing elements of a first type and at least a plurality of processing elements of a second type, the method comprising: for a computing application for each type of processing element, determining a parameter for the application indicative of a portion of application code which can be processed in parallel by the processing elements of that type; and determining, using the parameters obtained for the processing of the application by the processing elements of the at least first and at least second type, a degree by which an expected processing time of the application would be changed by varying a number of processing elements of one or more of the types, and assigning processing elements of the at least first and at least second type to the computing application so as to optimize a utilization of the processing elements of the parallel computing system.

In a yet still further aspect, the invention provides a method of designing a parallel computing system including a plurality of processing elements including at least a plurality of processing elements of a first type and a at least a plurality of processing elements of a second type, the method comprising setting a first number of processing elements of a first type, k_{d}, determining a parallelizable portion of a first concurrency distributed over the first number of processing elements of the first type; p_{d}, determining a parallelizable portion of a second concurrency distributed over a second number of processing elements of a second type, pₕ; and determining the second number of processing elements of the second type required to provide a required speed-up, S, of the parallel computing system using the values of k_{d}, p_{d}, pₕ, and S.

The present invention provides a technique to be used as a construction principle of modular supercomputers and data centres with interacting computer modules and a method for the dynamical operative control of allocations of resources in the modular system. The invention can be used to optimize the design of modular computing and data analytics systems as well as to optimize the dynamical adjustment of hardware resource in a given modular system.

The present invention can readily be extended to a situation involving a multitude of smaller parallel computing systems that are connected via the internet to central systems in data centres. This situation is called Edge Computing. In this case, the Edge Computing systems underlie conditions as to lowest possible energy consumption and low communication rates at large latencies in interacting with their data centres.

A method is provided to optimize the effectiveness of parallel and distributed computations as to energy, operating and investment costs as well as performance and other possible conditions. The invention follows a new, generalized form of Amdahl's Law

(GAL). The GAL applies to situations, where a workflow of computations (usually involving different interacting programs) or a given single program exhibit different concurrencies of their parts or program portions, respectively. The method is of particular benefit but not restricted to those computing problems where a majority of program portions of the problem can be efficiently executed on accelerated compute elements like for instance GPUs and can be scaled to large numbers of compute elements on a fine-grained basis, while the other program portions, the performance of which is limited by a dominating concurrency, are best to be executed on strong compute elements, as for instance represented by the cores of today's multi-threaded CPUs.

Utilizing the GAL, a modular supercomputer system or an entire data centre consisting of several modules can be designed in an optimal manner, taking into account constraints as investment budget, energy consumption or time to solution, and on the other hand it is possible to map a computational problem in an optimal manner on the appropriate compute hardware. Depending on the execution properties of the computational process, the mapping of resources can be dynamically adjusted by application of the GAL.

Preferred embodiments of the invention will now be described, by way of example only, with reference to the accompanying drawing showing a schematic arrangement of a parallel computing system.

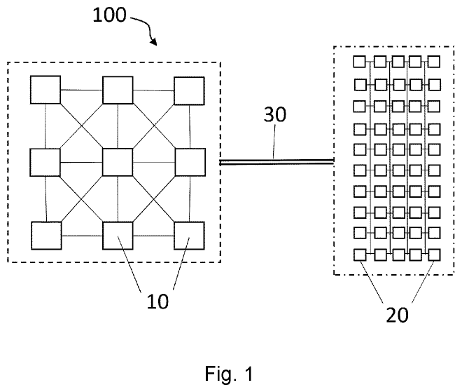

For a schematic illustration of the application of the invention reference is made to FIG. 1. FIG. 1 shows a parallel computing system 100 comprising a plurality of computing nodes 10 and a plurality of booster nodes 20. The computing nodes 10 are interconnected with each other and also the booster nodes 20 are interconnected with each other. A communication infrastructure 30 connects the computing nodes 10 with the booster nodes 20. The computing nodes 10 may each be a rack unit comprising multiple core CPU chips and the booster nodes 20 may each be a rack unit comprising multiple core GPU chips.

In real world situations, executing a given workflow or an individual program, one will be confronted with more than two concurrencies (as just used above). Let n different concurrencies kᵢ,i=1 . . . n occur, each contributing with a different code portion pᵢ(i=1 might define the scalar concurrency from above). Every such program portion can scale to its individual maximum number of cores, kᵢ. This means, beyond kᵢ, there is no relevant improvement as to the minimum computation time for this code portion if distributed to more than kᵢ compute elements. In this situation, the above setting of AL is generalized to

$$S = \frac{1}{{\sum }_{i = 1}^{n} \frac{{p}_{i}}{{k}_{i}}} ,$$

in a straightforward manner. In the following, this equation is called the “Generalized Amdahl's Law” (GAL). The dominant concurrency, k_{d}, is defined such that the effects on the concurrencies kᵢ for i≠d on the speed-up S are smaller than that of the dominant concurrency k_{d}, i.e.,

$$\frac{{p}_{i}}{{k}_{i}} < \frac{{p}_{d}}{{k}_{d}} , for i \neq d .$$

In order to determine the corresponding asymptotics for the GAL, one can follow the original AL and assume that all concurrencies kᵢ for i>d can be scaled to infinity. The maximal asymptotic speed-up Sₐ that can theoretically be reached is then given by

$${S}_{a} = {lim}_{{k}_{i} \to ∞ for i > d} \frac{1}{{Σ}_{i = 1}^{n} \frac{{p}_{i}}{{k}_{i}}} ≅ \frac{1}{{Σ}_{i = 1}^{d - 1} \frac{{p}_{i}}{{k}_{i}} + \frac{{p}_{d}}{{k}_{d}}} .$$

It is evident that this is limiting case and that in reality computing systems can only come close to it. If, as it is also often the case,

$$\frac{{p}_{i}}{{k}_{i}} ⪡ \frac{{p}_{d}}{{k}_{d}} ,$$

for i<d, the speed-up becomes

$${S}_{a} ≅ \frac{{k}_{d}}{{p}_{d}} .$$

In that idealized case, the possible speed-up is completely determined by the dominating concurrency k_{d}.

On computing platforms as given by a heterogeneous processor, a heterogeneous compute node or a modular supercomputer, the latter, for example, realized by the cluster-booster system of WO 2012/049247, compute elements with different compute characteristics are available. In principle, such situation allows to assign different code portions to the best suited compute elements as well as to the best suited number of such compute elements for each problem setting.

To give an instructive example, a modular supercomputer might consist of a multitude of standard CPUs connected by a supercomputer network, and a multitude of GPUs (along with the hosting (or administration) CPUs they need in order to be operated) again connected by a fast network. Both networks are assumed as being interlinked and ideally, but not necessarily, are of the same type. The crucial observation is that today's CPUs and GPUs exhibit very different frequencies as to the basic speed of their basic compute elements, usually called cores. The difference can be as large as a factor f, where the difference can more or less be 20≤f≤100, between CPUs and GPUs. Similar considerations hold for other technologies as specified above.

The present invention is leveraging this difference in a general sense. Let there be a factor ƒ>1 as to the peak performance between the compute elements of a system C and the compute elements of a system B. For C one can take a cluster of CPUs, for B a Booster”, i.e. a cluster of GPUs (where for the latter the GPUs, not their administering CPUs, are the devices with their compute elements (cores) important for this consideration).

Given the factor ƒ as to the peak performance in the case of two different compute elements involved, one will assign the lower concurrencies for i≤d to the compute elements with higher performance on system C (of which compute elements usually a smaller number is available), while the scalable code portions are assigned to the compute elements with lower performance (which are available in larger numbers) on system B. Let the performances be gauged with respect to the peak performance of the compute elements of system B, assigning ƒ=1 to the latter. It follows that

$$S = \frac{1}{{Σ}_{i = 1}^{n} \frac{{p}_{i}}{{f}_{i} {k}_{i}}} = \frac{1}{{Σ}_{i = 1}^{d - 1} \frac{{p}_{i}}{{fk}_{i}} + \frac{{p}_{d}}{{fk}_{d}} + {Σ}_{i = d + 1}^{n} \frac{{p}_{i}}{{k}_{i}}} ,$$

introducing factors ƒᵢ (for generality it would be possible to assume many different realizations of compute elements) into the above considerations, which here are chosen as ƒᵢ=ƒ for C and ƒᵢ=1 for B.

In the asymptotic limit, and again neglecting the less dominating concurrencies, the speed-up for the GAL in the case of systems with different compute elements is thus given by

$${S}_{a} ≅ \frac{{fk}_{d}}{{p}_{d}} .$$

As a consequence, one can benefit from strong compute elements to serve the dominating concurrencies, while one can leverage many less powerful (and thus much cheaper and much less power consuming) but also much larger amounts of compute elements for the scalable concurrencies.

Thus, the GAL on the one hand provides a design principle and on the other hand a dynamical operation principle for optimal parallel execution of tasks showing different concurrencies, as it is required in data centres, supercomputing facilities and for supercomputing systems.

In addition to the GAL, the computational speed of a module is determined by characteristics of the memory performance and the input/output performance of the processing elements used, the characteristics of the communication system on the modules as well as the characteristics of the communication system between the modules.

In fact, these features have different effects for different applications. Therefore, in first-order approximation, a second factor η_{A} needs to be introduced taking into account these characteristics. η_{A} is application dependent. This factor can be determined dynamically during code execution, which allows modifying the distribution characteristics of tasks according to the GAL in a dynamical manner. It also can be determined in advance, when the objective is to design a system, on a few test CPUs and GPUs respectively.

Reducing the GAL to describe two modular systems C for the lower dominating concurrency (d) and B to compute the high concurrency (h), one can take the application dependent efficiency determined on CPU and GPU into account in the joint factor η_{A} and get:

$$S ≅ \frac{1}{\frac{{p}_{d}}{{η}_{A} {fk}_{d}} + \frac{{p}_{h}}{{k}_{h}}} , \qquad ( Equation 1 )$$

Given the preceding formula, the practical objective is to optimize the speed-up S. Here, targets can be considered like: the design of a modular system as required in future supercomputing or data centres as well as the dynamically optimized assignment of resources on a modular computing system during operation, i.e. the execution of workflows or modular programs. The formula is open for application to many other targets.

It is straight forward to determine the parameters to run a specific program on a modular computing system. Then one can readily determine the parameters in equation (1) a priori or during execution and determine the configuration of partitions on the modular system or the optimized system for the given application.

Designing a modular supercomputer or a modular data centre, one can choose average characteristics of the given portfolio or one can take specific characteristics of important codes into account, depending on the preferences of the supercomputing or data centre. The result will be a set of average parameters or of specific parameters p_{d}, pₕ, η_{A}. Constraints like costs or energy consumption can be taken into account.

In order to illustrate the idea of optimizing the modular architecture, a simple situation is described and worked out in the following by explicitly carrying out such an optimization. The considerations made here can be readily generalized to take into account more complex situations by including more than two modules, higher-order network or processor characteristics or properties of the programs into account.

Here, for illustration with a simple example, the investment budget may be fixed to K as a constraint although as indicated other constraints may be considered such as energy consumption, time to solution or throughput, etc. Assuming for simplicity the costs of the modules and their interconnects to be roughly proportional to the number and the costs of the of compute elements k_{d}, kₕ and c_{d}, cₕ, respectively, it follows that

K=c_{d}k_{d}+Cₕkₕ. (Equation 2)

Inserting equation (2) into equation (1) leads to:

$$S = \frac{1}{\frac{{p}_{d}}{{η}_{A} {fk}_{d}} + \frac{{p}_{h}}{\frac{K - {c}_{d} {k}_{d}}{{c}_{h}}}} . \qquad ( Equation 3 )$$

With

$$\frac{d S}{d {k}_{d}} = 0$$

one can Tina an optimal solution maximizing the speed-up. This solution allows determining the optimal number of the—in this case—two different types of compute elements (e.g. in terms of compute cores of CPUs and GPUs):

$${k}_{d} = \frac{K}{{c}_{d}} \frac{1}{1 + \sqrt{{η}_{A} f \frac{{p}_{h} {c}_{h}}{{p}_{d} {c}_{d}}}} , \\ {k}_{h} = \frac{K}{{c}_{h}} \frac{1}{1 + \sqrt{\frac{1}{{η}_{A} f} \frac{{p}_{d} {c}_{d}}{{p}_{h} {c}_{h}}}} .$$

This simple design model can be readily generalized to an extended cost model and adapted to more complex situations involving other constraints as well. It can be applied to a diversity of different compute elements that are assembled in modules that are parallel computers.

In fact, the dynamical adjustment of the assignment of resources to a given computational task involves a similar recipe as followed before. The difference is that the dimensions of the overall architecture are fixed in this case.

A typical question in a data centre is, how much further resources it will require to double (or multiply by any factor) a given speed-up in case the time to solution or specific service level agreements are to be fulfilled. This question can be directly answered by means of equation (1).

Again an illustrative simple example is considered. A starting point here can be a pre-assigned partition with k_{d} compute elements on the primary module C of a modular system. How to choose the size of this partition a priori is in the hands of the user or can be determined by any other condition.

One question to answer is, what is then the required number of compute elements kₕ of the corresponding partition on module B in the modular computing system or the data centre in order to achieve a pre-assigned speed-up, S. One would assume that the parameters p_{d}, pₕ, η_{A}, and f are either known in advance or can be determined during the iterative execution of the code. In the latter case, the adjustment can be dynamically executed during the running of the modular code. As already said, k_{d} is assumed to be a fixed quantity for this problem setting. One could also start from a fixed number for kₕ on module B or from a constraint taken from actual costs of the operations. Again one can readily extend the approach for more complex problems or include more different types of compute elements.

The straightforward transformation of equation (1) leads to

$${k}_{h} = \frac{{p}_{h}}{\frac{1}{S} - \frac{{p}_{d}}{{η}_{A} {fk}_{d}}} ,$$

which allows for a dynamical adjustment of resource on B. It is evident that one can also tune the partition on C if reasonable. Such considerations will provide a controlled degree of freedom in the optimal assignment of the compute resources of a data centre.

A second, related question is what amount of resources it will take to increase or decrease the speed-up, S, from S_{old} to a wanted S_{new,} may be under the constraint of a changing service level agreement as to time to solution. The application of equation (1) for this case leads to

$${k}_{h , n e w} = \frac{{S}_{n e w}}{{S}_{old}} \frac{1}{\frac{{p}_{d}}{{p}_{h} {η}_{A} {fk}_{d}} ( 1 - \frac{{S}_{old}}{{S}_{n e w}} ) + \frac{1}{{k}_{h , old}}} .$$

Again, a dynamical adaption of assignment of resources is possible. This equation can be readily extended to more complicated situations.

It is evident that one can also tune the partition on C if required. On top it is possible to balance the use of resources on the two (or more) modules, in case one resource might be short or unused.

The computing nodes 10 can be considered to correspond to the cluster of CPUs C referred to above while the booster nodes 20 can be considered to correspond to the cluster of GPUs B. As indicated above, the invention is not limited to a system of just two types of processing units. Other processing units could also be added to the system, such as a cluster of tensor processing units TPUs or a cluster of quantum processing units QPUs.

The application of the invention relating to modular supercomputing can be based on any suitable communication protocol like the MPI (e.g. the message passing interface) or other variants that in principle enable communication between two or more modules.

The data centre architecture considered for the application of this invention is that of composable disaggregated infrastructures in the sense of modules, just in analogy to modular supercomputers. Such architectures are going to provide the level of flexibility, scalability and predictable performance that is difficult and costly and thus less effective to achieve with systems made of fixed building blocks, each repeating a configuration of CPU, GPU, DRAM and storage. The application of the invention relating to such composable disaggregated data centre architectures can be based on any suitable virtualization protocol. Virtual servers can be composed of such resource modules comprising of compute (CPU), acceleration (GPU), storage (DRAM, SDD, parallel file systems) and networks. The virtual servers can be provisioned and re-provisioned with respect to a chosen optimization strategy or a specific SLA, applying the GAL concept and its possible extensions. This can be carried out dynamically.

A widely spread variant of Edge Computing exploiting static or mobile compute elements at the edge interacting with a core system. The application of the invention allows to optimize the communication of the edge elements with the central compute modules in analogy or extending the above considerations.

1. A method of assigning resources of a parallel computing system for processing one or more computing applications, the parallel computing system including a predetermined number of processing elements of different types, at least a predetermined number of a first type and at least a predetermined number of processing elements of a second type, the method comprising:
for each computing application
for each type of processing element, determining a parameter for the application indicative of a portion of application code which can be processed in parallel by the processing elements of that type;
determining, using the parameters obtained for the processing of the application by the processing elements of the at least first and at least second type, a degree by which an expected processing time of the application would be changed by varying a number of processing elements of one or more of the types; and
assigning processing elements of the at least first and at least second type to the one or more computing applications so as to optimize a utilization of the processing elements of the parallel computing system.

2. A method of designing a parallel computing system having a plurality of processing elements of different types, including at least a plurality of processing elements of a first type and at least a plurality of processing elements of a second type, the method comprising:
for each type of processing element, determining a parameter indicative of a proportion of a respective processing task which can be processed in parallel by the processing elements of that type;
determining an optimal number of processing elements of at least one of the first and second types by one of:
(i) determining a point at which a processing speed of the system for the application does not change with number of processing elements of that type in an equation relating the processing speed, the parameters for the processing elements of the first and second type, a number of processing elements of the first type, a number of processing elements of that type and costs of the processing elements of the first and second type; and
(ii) for a desired change in processing time in a parallel computing system, using the parameters determined for each type of processing element to determine a sufficient change in a number of processing elements required to obtain the desired change in processing time, and
using the determined optimal number to construct the parallel computing system.

3. The method according to claim 1, wherein
the first processing element type has a higher processing performance than the second processing element type and the parameter determined for the first type of processing element is a parallelizable code portion of a lower scalability code part of an application and the parameter determined for the second type of processing element is a parallelizable code portion of a higher scalability code part of the application.

4. The method according to claim 1, wherein an overall cost factor and processing element type processing element cost factors are taken into consideration.

5. The method according to claim 4 wherein the cost factors are at least one of a financial cost, an energy consumption cost and a thermal cooling cost.

6. The method according to claim 1, wherein a service level agreement for providing an agreed time for a solution is used as a constraint for determining a required number of processing elements.

7. The method according to claim 1, wherein the optimum number is determined by manipulating an equation
$$S ≅ \frac{1}{\frac{{p}_{d}}{{η}_{A} {fk}_{d}} + \frac{{p}_{h}}{{k}_{h}}} ,$$
where S is a speed-up factor,
P_{d} is a parallelizable fraction of a dominant concurrency code part,
Pₕ is a parallelizable fraction of a concurrency code part with a higher scalability than the dominant concurrency,
k_{d} is a number of processing elements of the first type,
kₕ is a number of processing elements of the second type,
η_{A} is an adjustment factor, and
f is a relative processing speed factor.

8. The method according to claim 1, wherein the parallel computing system include one or more further types of processing element and a parameter indicative of a proportion of a respective processing task which can be processed in parallel by the processing elements of each further type is determined for each further type.

9. A method of assigning resources of a parallel computing system for processing one or more computing applications, the parallel computing system including a plurality of processing elements of different types, including at least a plurality of processing elements of a first type and at least a plurality of processing elements of a second type, the method comprising:
for a computing application
for each type of processing element, determining a parameter for the application indicative of a portion of application code which can be processed in parallel by the processing elements of that type; and
determining, using the parameters obtained for the processing of the application by the processing elements of the at least first and at least second type, a degree by which an expected processing time of the application would be changed by varying a number of processing elements of one or more of the types, and
assigning processing elements of the at least first and at least second type to the computing application so as to optimize a utilization of the processing elements of the parallel computing system.

10. The method of claim 9, wherein the step of assigning is performed following a manipulation of an equation
$$S ≅ \frac{1}{\frac{{p}_{d}}{{η}_{A} {fk}_{d}} + \frac{{p}_{h}}{{k}_{h}}} ,$$
where S is a speed-up factor,
P_{d} is a parallelizable fraction of a dominant concurrency code part,
Pₕ is a parallelizable fraction of a concurrency code part with a higher scalability than the dominant concurrency,
k_{d} is a number of processing elements of the first type,
kₕ is a number of processing elements of the second type,
η_{A} is an adjustment factor, and
f is a relative processing speed factor.

11. The method of claim 9, wherein the parallel computing system includes at least one further processing element type and processing elements of one or more further type are assigned to the computing application.

12. The method of claim 9, wherein a service level agreement requiring a particular level of service is used as a constraint to determine the assignment of processing element resources to an application.

13. A method of designing a parallel computing system including a plurality of processing elements including at least a plurality of processing elements of a first type and a at least a plurality of processing elements of a second type, the method comprising:
setting a first number of processing elements of a first type, k_{d},
determining a parallelizable portion of a first concurrency distributed over the first number of processing elements of the first type; p_{d},
determining a parallelizable portion of a second concurrency distributed over a second number of processing elements of a second type, pₕ; and
determining the second number of processing elements of the second type required to provide a required speed-up, S, of the parallel computing system using the values of k_{d}, P_{d}, Pₕ, and S.

14. The method according to claim 2, wherein the first processing element type has a higher processing performance than the second processing element type and the parameter determined for the first type of processing element is a parallelizable code portion of a lower scalability code part of an application and the parameter determined for the second type of processing element is a parallelizable code portion of a higher scalability code part of the application.

15. The method according to claim 2, wherein an overall cost factor and processing element type processing element cost factors are taken into consideration.

16. The method according to claim 15, wherein the cost factors are at least one of a financial cost, an energy consumption cost and a thermal cooling cost.

17. The method according to claim 2, wherein a service level agreement for providing an agreed time for a solution is used as a constraint for determining a required number of processing elements.

18. The method according to claim 2, wherein the optimum number is determined by manipulating an equation
$$S ≅ \frac{1}{\frac{{p}_{d}}{{η}_{A} {fk}_{d}} + \frac{{p}_{h}}{{k}_{h}}} ,$$
where S is a speed-up factor,
P_{d} is a parallelizable fraction of a dominant concurrency code part,
Pₕ is a parallelizable fraction of a concurrency code part with a higher scalability than the dominant concurrency,
k_{d} is a number of processing elements of the first type,
kₕ is a number of processing elements of the second type,
η_{A} is an adjustment factor, and
f is a relative processing speed factor.

19. The method according to claim 2, wherein the parallel computing system include one or more further types of processing element and a parameter indicative of a proportion of a respective processing task which can be processed in parallel by the processing elements of each further type is determined for each further type.
